(19) United States
(12) Patent Application Publication
(10) Pub. No.: US 2026/0110770 A1
(43) Pub. Date: Apr. 23, 2026

(54) PROVIDING AT LEAST ONE SENSING-RELATED SERVICE VIA PROCESSING SENSING-RELATED DATA THAT IS GENERATED WITHIN OR AS PART OF A MOBILE COMMUNICATION NETWORK

(71) Applicant: Deutsche Telekom AG, Bonn (DE)

(72) Inventor: Arndt KADELKA, Cologne (DE)

(21) Appl. No.: 19/156,940

(22) PCT Filed: Feb. 26, 2024
(86) PCT No.: PCT/EP2024/054735

§ 371 Date: Aug. 15, 2025

(30) Foreign Application Priority Data
Feb. 28, 2023 (EP) 23158910.2

(51) Int. Cl. G01S 7/00; H04W 4/38; H04W 64/00

(52) U.S. Cl. CPC G01S 7/006; H04W 4/38; H04W 64/00

(57) ABSTRACT

A method for providing at least one sensing-related service by means of processing sensing-related data that is generated within or as part of a mobile communication network includes: in a first step, first stage sensing inference data are provided to at least one sensing edge server, wherein the at least one sensing edge server generates second stage sensing inference data; and in a second step, the second stage sensing inference data are provided to at least one sensing application server, wherein the at least one sensing application server provides sensing-related services and/or generates sensing application data.

### CROSS-REFERENCE TO PRIOR APPLICATIONS

This application is a U.S. National Phase application under 35 U.S.C. § 371 of International Application No. PCT/EP2024/054735, filed on Feb. 26, 2024, and claims benefit to European Patent Application No. EP 23158910.2, filed on Feb. 28, 2023. The International Application was published in English on Sep. 6, 2024 as WO 2024/179949 A1 under PCT Article 21(2).

### FIELD

The present invention relates a method for providing at least one sensing-related service via processing sensing-related data that is generated within or as part of a mobile communication network, wherein the mobile communication network comprises at least a first sensing-capable or sensing-enabled entity or functionality and a second sensing-capable or sensing-enabled entity or functionality, wherein the at least one sensing-capable or sensing-enabled entity or functionality transmits a radiofrequency sensing signal, wherein, as a result of the radiofrequency sensing signal being transmitted, a radiofrequency sensing reception signal is received by either the first sensing-capable or sensing-enabled entity or functionality or the second sensing-capable or sensing-enabled entity or functionality, wherein via the radiofrequency sensing reception signal information about the environment of the first and/or second sensing-capable or sensing-enabled entities or functionalities is able to be gathered as first stage sensing inference data.

Furthermore, the present invention relates to a system or a mobile communication network for providing at least one sensing-related service via processing sensing-related data that is generated within or as part of a mobile communication network, wherein the mobile communication network comprises at least a first sensing-capable or sensing-enabled entity or functionality and a second sensing-capable or sensing-enabled entity or functionality, wherein the at least one sensing-capable or sensing-enabled entity or functionality transmits a radiofrequency sensing signal, wherein, as a result of the radiofrequency sensing signal being transmitted, a radiofrequency sensing reception signal is received by either the first sensing-capable or sensing-enabled entity or functionality or the second sensing-capable or sensing-enabled entity or functionality, wherein via the radiofrequency sensing reception signal information about the environment of the first and/or second sensing-capable or sensing-enabled entities or functionalities is able to be gathered as first stage sensing inference data.

Additionally, the present invention relates to a sensing edge server or to a sensing application server or to a sensing-capable or sensing-enabled entity or functionality, especially as part of embodiments of an inventive system or an inventive mobile communication network, for providing at least one sensing-related service via processing sensing-related data that is generated within or as part of a mobile communication network.

Furthermore, the present invention relates to a program and to a computer-readable medium for providing at least one sensing-related service via processing sensing-related data that is generated within or as part of a mobile communication network according to exemplary embodiments of the inventive method.

### BACKGROUND

Mobile communication networks such as public land mobile networks are typically realized as cellular mobile communication networks, i.e. comprising (or using or being associated or assigned to a radio access network comprising) radio cells. Such cellular systems are known conforming to different mobile communication standards or radio access technologies, like 2G/3G/4G/5G/6G radio access technologies (referring to the different generations of radio access technologies) and typically comprise (or consist of) cells (or radio cells) of one or a plurality of the respective radio access technology/radio access technologies, which are typically organized throughout a country (or a part of or a region within a country) in a repeating pattern of (radio) cells (and associated base station entities) which belong to (or are used by or associated or assigned to) a mobile network operator (MNO).

Wireless sensing technologies have originated from the most widely used sensing technology known as radar (radio detection and ranging), where radio waves are exploited to determine distance, angle, or instantaneous velocity of objects. Nowadays, this principle is exploited for example by lidar (light detection and ranging) systems that are capable of obtaining an image of the environment around a sensor. A lidar system may be either a stand-alone device or integrated in a mobile device or a vehicle.

Via realizing sensing capabilities in or as part of mobile communication networks, primarily via one or a plurality of sensing-capable or sensing-enabled entities or functionalities that are generating and transmitting radiofrequency sensing signals, it is possible to obtain information regarding either transmission channel properties between different stations, especially base station entities or user equipments, and/or regarding objects from where such radiofrequency sensing signals are reflected.

Even though such sensing capabilities are able to procure further information regarding transmission channels and/or objects, especially moving objects, nearby or in the vicinity of the respective sensing-capable or sensing-enabled entities or functionalities, mobile radio technologies (mobile radio access technologies) and radar have developed over decades more or less independently. However, lately the convergence of both technologies is increasing: Future advances in mobile communications (5G Advanced and 6G) anticipate that advanced radio sensing functions will become important services of mobile broadband (radio) networks. Joint communication and sensing (JCaS) will address a combined radio interface serving both communication and sensing. Sensing in 6G is considered in an even broader range, especially referring to the ability of devices (e.g. base station entities or user equipments) to detect and gather information about the environment around them. This could include using advanced sensor technologies to gather information about the physical world, or using machine learning algorithms to analyze data from one or multiple sensors in real-time. Furthermore, for 6G, integrated communication and sensing (ICaS) is considered that improves the JCaS concept by providing common waveforms and other radio functions. An initial step for the introduction of sensing is currently under preparation for 3GPP Rel-19, providing sensing functionalities on top of 5G radio for identified use cases.

Typically, wireless sensing technologies are applied in stand-alone systems that are designed for dedicated applications and use cases, e.g. autonomous driving, and a lot of research and development work has been conducted to develop methods and algorithms for problems arising in connection with these specific applications or use cases. In contrast to these rather specific sensing applications, sensing in cellular mobile broadband networks typically needs to serve diverse use cases.

### SUMMARY

In an exemplary embodiment, the present invention provides a method for providing at least one sensing-related service by means of processing sensing-related data that is generated within or as part of a mobile communication network. The mobile communication network comprises at least a first sensing-capable or sensing-enabled entity or functionality and a second sensing-capable or sensing-enabled entity or functionality. The at least one sensing-capable or sensing-enabled entity or functionality transmits a radiofrequency sensing signal. As a result of the radiofrequency sensing signal being transmitted, a radiofrequency sensing reception signal is received by either the first sensing-capable or sensing-enabled entity or functionality or the second sensing-capable or sensing-enabled entity or functionality or both. By means of the radiofrequency sensing reception signal information about the environment of the first and second sensing-capable or sensing-enabled entities or functionalities is able to be gathered as first stage sensing inference data. The mobile communication network comprises or is associated or assigned to at least one sensing edge server and at least one sensing application server. In order to provide at least one sensing-related service, the method comprises the following steps: in a first step, the first stage sensing inference data are provided to the at least one sensing edge server, wherein the at least one sensing edge server generates second stage sensing inference data, wherein, in a first sub-step of the first step, the sensing edge server performs a first inference step, and wherein, in a second sub-step of the first step, the sensing edge server performs a second inference step, wherein the second stage sensing inference data correspond to the result of the second inference step, wherein the first inference step involves data fusion of different first stage sensing inference data provided by different sensing-capable or sensing-enabled entities or functionalities into a general coordinate system or into an absolute coordinate system, wherein the second inference step involves the sensing edge server identifying objects and providing object information; and in a second step, the second stage sensing inference data are provided to the at least one sensing application server, wherein the at least one sensing application server provides sensing-related services and/or generates sensing application data.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically and exemplarily illustrates a base station as a sensing-capable or sensing-enabled entity or functionality which transmits signals (radiofrequency sensing signals) and receives the reflected signals (radiofrequency sensing reception signals), the echoes, of a target in a mono-static operation scenario.

FIG. 2 schematically and exemplarily illustrates a bi-static operation scenario, where a target is illuminated (i.e. radiofrequency sensing signals sent) by a first base station entity as a first sensing-capable or sensing-enabled entity or functionality and (radiofrequency sensing reception signals) detected by a second base station entity as a second sensing-capable or sensing-enabled entity or functionality.

FIG. 3 schematically and exemplarily illustrates a situation, where a target is illuminated (i.e. radiofrequency sensing signals sent) and (radiofrequency sensing reception signals) detected, respectively, by a first, second and third base station entity as a first, second and third sensing-capable or sensing-enabled entity or functionality

FIG. 4 schematically and exemplarily illustrates a method according to the present invention as well as functional elements involved, namely, besides first, second and third sensing-capable or sensing-enabled entities or functionalities, a sensing edge server, processing first stage sensing inference data received from one or more of the sensing-capable or sensing-enabled entities or functionalities, and a sensing application server providing sensing-related services and/or generating sensing application data based on second stage sensing inference data received from the sensing edge server or from a plurality of sensing edge servers.

FIG. 5 schematically and exemplarily illustrates a possibility of first stage sensing inference data, especially as a radar-like image having multiple targets, wherein a data element is exemplarily represented as a feature vector.

FIG. 6 schematically and exemplarily illustrates inference steps performed in the sensing edge server.

FIGS. 7, 8 and 9 schematically and exemplarily illustrate different examples of the information exchange between a sensing edge server and a sensing-capable or sensing-enabled entity or functionality, when the first requests from the latter continuous mode, periodic mode and one-shot request, respectively.

FIGS. 10, 11 and 12 schematically and exemplarily illustrate different examples of the information exchange and the interface between a sensing edge server towards the sensing application server, showing different approaches, especially Stream-based application programming interface, Pub/Sub application programming interface, and REST application programming interface, respectively.

### DETAILED DESCRIPTION

Exemplary embodiments of the present invention provide a technically simple, effective and cost-effective solution for providing at least one sensing-related service via processing sensing-related data that is generated within or as part of a mobile communication network, wherein the mobile communication network comprises at least a first sensing-capable or sensing-enabled entity or functionality and a second sensing-capable or sensing-enabled entity or functionality, wherein the at least one sensing-capable or sensing-enabled entity or functionality transmits a radiofrequency sensing signal, wherein, as a result of the radiofrequency sensing signal being transmitted, a radiofrequency sensing reception signal is received by either the first sensing-capable or sensing-enabled entity or functionality or the second sensing-capable or sensing-enabled entity or functionality, wherein via the radiofrequency sensing reception signal information about the environment of the first and/or second sensing-capable or sensing-enabled entities or functionalities is able to be gathered as first stage sensing inference data, wherein a more general applicability and less use case-specific or application-specific usage of the sensing inference data is possible. Further exemplary embodiments of the present invention provide a corresponding system or mobile communication network, a corresponding sensing edge server, a corresponding sensing application server, a corresponding sensing-capable or sensing-enabled entity or functionality, and a corresponding program and computer-readable medium.

In an exemplary embodiment, the present invention provides a method for providing at least one sensing-related service via processing sensing-related data that is generated within or as part of a mobile communication network, wherein the mobile communication network comprises at least a first sensing-capable or sensing-enabled entity or functionality and a second sensing-capable or sensing-enabled entity or functionality, wherein the at least one sensing-capable or sensing-enabled entity or functionality transmits a radiofrequency sensing signal, wherein, as a result of the radiofrequency sensing signal being transmitted, a radiofrequency sensing reception signal is received by either the first sensing-capable or sensing-enabled entity or functionality or the second sensing-capable or sensing-enabled entity or functionality, wherein via the radiofrequency sensing reception signal information about the environment of the first and/or second sensing-capable or sensing-enabled entities or functionalities is able to be gathered as first stage sensing inference data, wherein the mobile communication network comprises or is associated or assigned to at least one sensing edge server and at least one sensing application server,
wherein, in order to provide at least one sensing-related service, the method comprises the following steps:
   in a first step, the first stage sensing inference data are provided to the at least one sensing edge server, wherein the at least one sensing edge server generates second stage sensing inference data,
   in a second step, the second stage sensing inference data are provided to the at least one sensing application server, wherein the at least one sensing application server provides sensing-related services and/or generates sensing application data.

It is thereby advantageously possible according to the present invention to provide for a cascading of data inference from integrated communication and sensing in cellular mobile broadband networks. Hence, in contrast to the rather specific conventionally known sensing applications, applying sensing in cellular mobile broadband networks according to the present invention advantageously provides the possibility to serve diverse use cases, and, additionally or cumulatively, apply a service oriented architecture such as used in mobile broadband (cellular) networks. Hence, according to the present invention, instead of optimizing and aggregating sensing (raw) data for specific use cases and/or stand-alone applications, it is advantageously possible to provide sensing services in mobile broadband (cellular) networks that provide functions and internal services that serve multiple—and diverse—use cases whilst building on a cellular system architecture. According to the present invention, it is advantageously possible to serve various application demands, which is a benefit due to the large variety of potential sensing use cases. With regard to positioning, it is to be understood that in this respect, integrated communication and sensing (ICaS) significantly differs from positioning in mobile broadband networks, as the sensing targets are not actively involved in the inference process; hence, algorithms defined for positioning cannot be applied to sensing, and—while, in principle, every object in the environment can be a sensing target (i.e. a sensed object)—in case of positioning, targets are defined only by the positioning capabilities of the co-located user equipments. Furthermore, a sensing object can be defined by much more features than only the location information (as it is the case of positioning). Furthermore, user equipment detection/identification/tracking are inherently part of a positioning solution (since user equipments are “known” to the system); however, in a sensing approach, this information is not given a priori, it is typically needed to be “learned” from the measured data.

Integrated communication and sensing, ICaS, base station entities and user equipments (i.e. sensing-capable or sensing-enabled entities or functionalities) have to serve both communication and sensing. Due to the extra processing needs to infer by these sensing features and applications, it is advantageously possible according to the present invention that especially base station entities—but also user equipments—are relaxed from these application-driven tasks. In this sense, it is proposed, according to the present invention, to split the sensing inference accordingly, and to apply, or to provide for, a cascading of data inference from integrated communication and sensing in cellular mobile broadband networks.

In conventionally known mobile communication networks, several sensing-related use cases are at least contemplated. This includes, e.g., the following: intruder detection in smart home, pedestrian and/or animal intrusion detection on a highway, intruder detection in surroundings of smart home, sensing for railway intrusion detection, automated guided vehicles, AGV, detection and tracking in factories, unmanned aerial vehicle, UAV, flight trajectory tracing, sensing at crossroads with/without obstacle, sensing to avoid unmanned aerial vehicle collision, sensing for unmanned aerial vehicle intrusion detection, sensing for tourist spot traffic management, unmanned aerial vehicle or vehicle or pedestrian detection near smart grid equipment, autonomous mobile robot, AMR, collision avoidance in smart factories. All of these use cases use one or more of object recognition and detection, object localization and/or object tracking. In contrast to localization technologies, sensing services operate with passive objects. Passive radio measurements of one or many receivers allow to infer sensing data. Thereby, improved radio capabilities such as massive multiple input multiple output, MIMO, are applied. With higher frequencies and increased bandwidths, the sensing performance (accuracies, resolutions) is increased, antenna sizes will be able to be reduced.

According to the present invention, at least one sensing-related service is able to be provided, via processing sensing-related data that is generated within a mobile communication network, i.e. wherein at least a part or parts of the mobile communication network help to generate such sensing-related data. According to the present invention, this is able to be realized via at least a first sensing-capable or sensing-enabled entity or functionality and a second sensing-capable or sensing-enabled entity or functionality. These sensing-capable or sensing-enabled entities or functionalities are typically base station entities that are used, within or as part of the mobile communication network, for communication purposes, i.e. in order to provide communication services to user equipments. However, also user equipments might be used, or participate, according to the present invention, in generating sensing-related data; hence, sensing-capable or sensing-enabled entities or functionalities might also correspond to user equipments. According to the present invention, sensing relates to obtaining information regarding the environment of such a sensing-capable or sensing-enabled entity or functionality via using (and analyzing) incoming radiofrequency signals (sensing reception signals) that are the result of the interactions (especially reflections) of previously transmitted radiofrequency signals (sensing signals) with the environment (e.g. objects having the capability to reflect radiofrequency signals) of the sensing-capable or sensing-enabled entity or functionality, wherein the previously transmitted radiofrequency signals (sensing signals) could either be radiofrequency signals having been transmitted by the same sensing-capable or sensing-enabled entity or functionality, or radiofrequency signals (sensing signals) having been transmitted by another sensing-capable or sensing-enabled entity or functionality, or both. Hence, the at least one sensing-capable or sensing-enabled entity or functionality transmits a radiofrequency sensing signal, wherein, as a result of the radiofrequency sensing signal being transmitted, a radiofrequency sensing reception signal is received by either the (same) first sensing-capable or sensing-enabled entity or functionality or the second sensing-capable or sensing-enabled entity or functionality (or by both of them). Via the radiofrequency sensing reception signal (or plurality of such sensing reception signals)—information is able to be gathered (especially via at least initially processing such sensing reception signal(s)) about the environment of the first and/or second sensing-capable or sensing-enabled entities or functionalities; in the context of the present invention, such information are referred to as first stage sensing inference data. In addition to the sensing-capable or sensing-enabled entities or functionalities, the mobile communication network comprises or is associated or assigned to, according to the present invention, at least one sensing edge server and at least one sensing application server in order to further process sensing-related data, and especially the first stage sensing inference data provided by the sensing-related or sensing-enabled entities or functionalities. Hence, according to the present invention, in order to provide at least one sensing-related service, the method comprises the steps of:
the first stage sensing inference data being provided (or transmitted, by the respective sensing-capable or sensing-enabled entity or functionality) to the at least one sensing edge server, wherein the at least one sensing edge server generates second stage sensing inference data, and furthermore,
the second stage sensing inference data being provided to the at least one sensing application server for providing sensing-related services and/or for generating sensing application data.

According to the present invention, it is advantageously possible and preferred that the first and second sensing-capable or sensing-enabled entities or functionalities use sensing raw data, especially based on radiofrequency transmission and/or reception measurements, especially time-of-arrival data, ToA data, angle-of-arrival data, AoA data, angle-of-departure data, AoD data, and/or doppler data, especially from the various beams of at least one massive multiple input multiple output, MIMO, antenna entity or functionality, wherein especially the first and second sensing-capable or sensing-enabled entities or functionalities are used for integrated communication and sensing, ICaS, and/or for joint communication and sensing, JCaS capabilities, and especially serve both communication purposes and sensing purposes.

It is thereby advantageously possible to easily and effectively implement exemplary embodiments of the inventive method.

According to the present invention, it is furthermore advantageously possible and preferred that the first stage sensing inference data comprise at least one out of the following:
radar-like images, especially in a relative coordinate system,
elements with significant sensing information,
further information available during local analysis at the first and second sensing-capable or sensing-enabled entities or functionalities, especially velocity indications, especially inferred from doppler measurements, range resolution, angular resolution, channel observations,
time-sequencing of static images, especially time-stamped image streams, especially of radar-like images,
a vector of features regarding at least a part of the radar-like images, the vector of features especially comprising data regarding
   the intensity of the received signal,
   the relative velocity derived from doppler measurements and/or
   a self-assessment information regarding one or a plurality of the inferred properties based on the respective sensing-capable or sensing-enabled entity or functionality.

It is thereby advantageously possible to easily and effectively implement exemplary embodiments of the inventive method.

According to the present invention, it is furthermore advantageously possible and preferred that, in a first sub-step of the first step, the sensing edge server performs a first inference step, and wherein, in a second sub-step of the first step, the sensing edge server performs a second inference step, wherein the second stage sensing inference data correspond to the result of the second inference step, wherein especially, the first inference step involves transforming the sensing inference data into a general coordinate system or in an absolute coordinate system, especially transformed from local information into the general coordinate system or into the absolute coordinate system, wherein especially, the second inference step involves the sensing edge server identifying objects and providing object information, especially defined data on object level, especially in a defined format, preferably using JavaScript Object Notation, JSON.

It is thereby advantageously possible to easily and effectively implement exemplary embodiments of the inventive method.

Furthermore, it is advantageously possible and preferred according to the present invention that the second stage sensing inference data are generated via at least one out of the following:
receiving different first stage sensing inference data or streams of first stage sensing inference data,
data fusion of different first stage sensing inference data provided by different sensing-capable or sensing-enabled entities or functionalities, especially data fusion into the general coordinate system or into the absolute coordinate system,
model inference and/or artificial intelligence-based or machine learning-based inference such as to derive results on:
   object detection,
   object identification, especially the shape, the material and/or the body of the object,
   object localization, especially in the absolute coordinate system,
   object tracking,
   environment information, especially regarding buildings or plants,
      wherein especially, the second stage sensing inference data comprise a generalized granularity.

It is thereby advantageously possible to easily and effectively implement exemplary embodiments of the inventive method.

Furthermore, it is advantageously possible and preferred according to the present invention that the first stage sensing inference data are transmitted, by the different sensing-capable or sensing-enabled entities or functionalities, and received, by the sensing edge server involving or according to at least one out of the following:
a continuous mode, wherein the sensing-capable or sensing-enabled entities or functionalities almost continuously provide streams of first stage sensing inference data, and the sensing edge server is almost continuously able to update object information,
a periodic mode, wherein the sensing edge server periodically updates the sensing information, wherein the periodicity is especially negotiated between the sensing-capable or sensing-enabled entities or functionalities and the sensing edge server,
a one-shot request, wherein the sensing edge server requests one-time sensing information from the sensing-capable or sensing-enabled entities or functionalities.

It is thereby advantageously possible to easily and effectively implement exemplary embodiments of the inventive method.

According to a further preferred embodiment of the present invention, the second stage sensing inference data are transmitted, by the sensing edge server, and received, by the sensing application server, involving an application programming interface, especially according to at least one out of the following:
a representational state transfer, REST, application programming interface, especially in case that the sensing edge server requests one-time sensing information from the sensing-capable or sensing-enabled entities or functionalities,
a publication-subscription application programming interface, especially using WebSocket, MQ telemetry transport, MQTT, especially in case that the sensing edge server and the sensing-capable or sensing-enabled entities or functionalities communicate according to the periodic mode operation,
a stream-based application programming interface, especially in case that the sensing edge server and the sensing-capable or sensing-enabled entities or functionalities communicate according to the continuous mode operation.

Furthermore, the present invention relates to a system or to a telecommunications network for providing at least one sensing-related service via processing sensing-related data that is generated within or as part of a mobile communication network, wherein the mobile communication network comprises at least a first sensing-capable or sensing-enabled entity or functionality and a second sensing-capable or sensing-enabled entity or functionality, wherein the at least one sensing-capable or sensing-enabled entity or functionality transmits a radiofrequency sensing signal, wherein, as a result of the radiofrequency sensing signal being transmitted, a radiofrequency sensing reception signal is received by either the first sensing-capable or sensing-enabled entity or functionality or the second sensing-capable or sensing-enabled entity or functionality, wherein via the radiofrequency sensing reception signal information about the environment of the first and/or second sensing-capable or sensing-enabled entities or functionalities is able to be gathered as first stage sensing inference data,
wherein the mobile communication network comprises or is associated or assigned to at least one sensing edge server (and at least one sensing application server,
wherein, in order to provide at least one sensing-related service, the system of mobile communication network is configured such that:
   the first stage sensing inference data are provided to the at least one sensing edge server, wherein the at least one sensing edge server generates second stage sensing inference data,
   the second stage sensing inference data are provided to the at least one sensing application server, wherein the at least one sensing application server provides sensing-related services and/or generates sensing application data.

Furthermore, the present invention relates to a sensing edge server or to a sensing application server or to a sensing-capable or sensing-enabled entity or functionality, especially as part of exemplary embodiments of an inventive system or an inventive mobile communication network, for providing at least one sensing-related service via processing sensing-related data that is generated within or as part of a mobile communication network, wherein the sensing edge server and/or the sensing application server communicate, at least indirectly, with at least the sensing-capable or sensing-enabled entity or functionality, wherein the sensing-capable or sensing-enabled entity or functionality gathers information about its environment as first stage sensing inference data,
wherein, in order to provide at least one sensing-related service, the sensing edge server and/or the sensing application server and/or the sensing-capable or sensing-enabled entity or functionality is configured such that:
   the first stage sensing inference data are provided, by the sensing-capable or sensing-enabled entity or functionality, to the at least one sensing edge server, wherein the at least one sensing edge server generates second stage sensing inference data,
   the second stage sensing inference data are provided to the at least one sensing application server, wherein the at least one sensing application server provides sensing-related services and/or generates sensing application data.

Additionally, the present invention relates to a program comprising a computer readable program code, which, when executed on a computer and/or on a sensing-capable or sensing-enabled entity or functionality and/or on a sensing edge server and/or on a sensing application server, or in part on a sensing-capable or sensing-enabled entity or functionality and/or in part on a sensing edge server and/or in part on a sensing application server, causes the computer and/or the sensing-capable or sensing-enabled entity or functionality and/or the sensing edge server and/or the sensing application server to perform exemplary embodiments of an inventive method.

Additionally, the present invention relates to a computer-readable medium comprising instructions which when executed on a computer and/or on a sensing-capable or sensing-enabled entity or functionality and/or on a sensing edge server and/or on a sensing application server, or in part on a sensing-capable or sensing-enabled entity or functionality and/or in part on a sensing edge server and/or in part on a sensing application server, causes the computer and/or the sensing-capable or sensing-enabled entity or functionality and/or the sensing edge server and/or the sensing application server to perform exemplary embodiments of an inventive method.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

The present invention will be described with respect to particular embodiments and with reference to certain drawings, but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

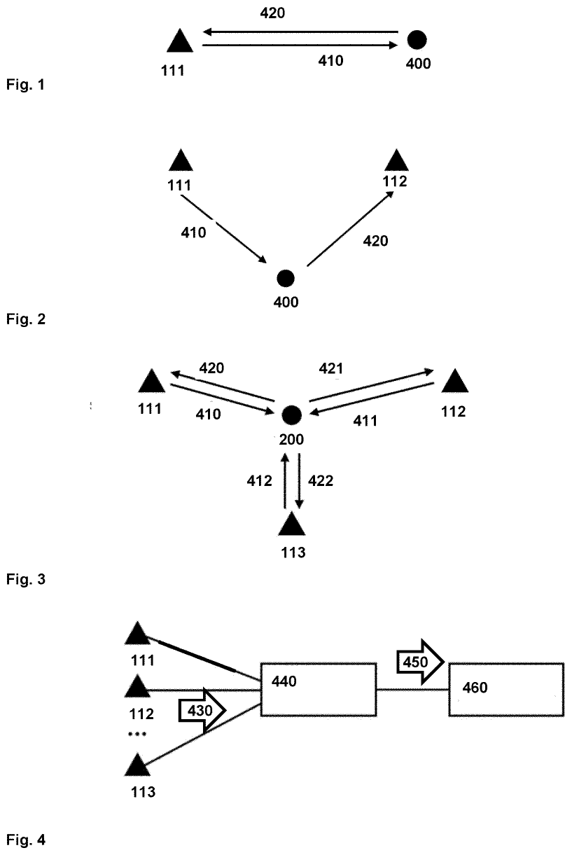

In FIG. 1, a base station entity as a (first) sensing-capable or sensing-enabled entity or functionality 111 is schematically and exemplarily represented, which (first) sensing-capable or sensing-enabled entity or functionality 111 transmits signals (radiofrequency sensing signals 410) and receives the reflected signals (radiofrequency sensing reception signals 420), the echoes, of a target 400 in a mono-static sensing operation scenario.

In FIG. 2, a bi-static operation scenario is schematically and exemplarily shown, where a target 400 is illuminated—i.e. radiofrequency sensing signals 410 sent—by a first base station entity as a first sensing-capable or sensing-enabled entity or functionality 111 and radiofrequency sensing reception signals 420 (resulting from the radiofrequency sensing signals 410) detected by a second base station entity as a second sensing-capable or sensing-enabled entity or functionality 112.

In FIG. 3, a situation is schematically and exemplarily represented, where a target 400 is illuminated (i.e. radiofrequency sensing signals sent) and (radiofrequency sensing reception signals) detected, respectively, by a first, second and third base station entity as first, second and third sensing-capable or sensing-enabled entities or functionalities 111, 112, 113 (i.e. FIG. 3 depicts mono-static sensing of three base stations 111, 112, 113). The first sensing-capable or sensing-enabled entity or functionality 111 sends, or transmits, a first radiofrequency sensing signal 410 and receives—as a result thereof—a first radiofrequency sensing reception signal 420. The second sensing-capable or sensing-enabled entity or functionality 112 sends, or transmits, a second radiofrequency sensing signal 411 and receives—as a result thereof—a second radiofrequency sensing reception signal 421. The third sensing-capable or sensing-enabled entity or functionality 113 sends, or transmits, a third radiofrequency sensing signal 412 and receives—as a result thereof—a third radiofrequency sensing reception signal 422. Furthermore, especially depending on the respective timing of the first, second and third radiofrequency sensing signals 410, 411, 412, e.g., the first radiofrequency sensing reception signal 420 may be a result, especially besides the first radiofrequency sensing signal 410, of at least one of the second and third radiofrequency sensing signals 411, 412, and analogously for the other radiofrequency sensing reception signals 421, 422.

Typically, in mono-static operation—cf. FIG. 1—, the transmitter (of radiofrequency sensing signals 410, 411, 412) and the receiver (of radiofrequency sensing reception signals 420, 421, 422) are co-located in the sensing-capable or sensing-enabled entities or functionalities 111, 112, 113 (i.e., typically base station entities and/or user equipments), respectively, especially with full-duplex capability. The measurements of ToA (Time-of-Arrival), AoA (Angle-of-Arrival), AoD (Angle-of-Departure), and Doppler of each of the resolved (radiofrequency signal propagation) paths correspond to the detection of a target 400, where the location is relative to the coordinate system of the sensing-capable or sensing-enabled entities or functionalities 111, 112, 113 (i.e., typically base station entities and/or user equipments), respectively.

In contrast to mono-static operation, in bi/multi-static operation—cf. FIG. 2 and also FIG. 3—, the transmitter (of radiofrequency sensing signals 410, 411, 412) and the receiver (of radiofrequency sensing reception signals 420, 421, 422) are located at different sites, i.e. a (radiofrequency sensing) signal between two sensing-capable or sensing-enabled entities or functionalities such as a base station entity and a user equipment, such signal to the user equipment is able to be used to estimate ToA, AoA, AoD, and Doppler of each of the resolved (radiofrequency signal propagation) paths. In case the two sensing-capable or sensing-enabled entities or functionalities rather correspond to two base station entities, the targets are detected, and their location estimated especially in an absolute joint coordinate system of these base station entities.

In FIG. 4, a method according to the present invention is schematically and exemplarily shown. Furthermore, functional elements involved, namely, besides first, second and third sensing-capable or sensing-enabled entities or functionalities 111, 112, 113, a sensing edge server 440, processing first stage sensing inference data 430 received from one or more of the sensing-capable or sensing-enabled entities or functionalities 111, 112, 113, and a sensing application server 460 providing sensing-related services and/or generating sensing application data based on second stage sensing inference data 450 received from the sensing edge server 440 or from a plurality of sensing edge servers. Hence, the functional elements involved according to the present invention comprise:
the sensing-capable or sensing-enabled entities or functionalities (or, sensing base stations) 111, 112, 113 with one or more mono-static sensing capable transmission and/or reception capabilities, TX/RX, especially antenna entities or functionalities and corresponding transmission and reception circuitry, wherein—especially in case of integrated communication and sensing, ICaS, sensing and communication is performed by the same base station HW (i.e. sensing-capable or sensing-enabled entities or functionalities 111, 112, 113;
sensing edge server 440 processing data from one or more sensing base stations 111, 112, 113;
sensing application server 460 realizing use case(s) based upon sensing detection data (second stage sensing inference data 450) received from the sensing edge server 440 with optional fusion of data from external sources (e.g. provided from dedicated stand-alone sensors).
   According to the present invention, in each function (i.e. at each stage) dedicated sensing data inference is carried out. A defined inference result is provided at the interfaces to the subsequent function.

Hence, FIG. 4 shows the cascading of sensing data inference, i.e. the sensing-capable or sensing-enabled entities or functionalities 111, 112, 113 generate—from or based on the processing of radiofrequency sensing signals 420, 421, 422—first stage sensing inference data 430, and provide these first stage sensing inference data 430 to the sensing edge server 440 (or to the plurality of sensing edge servers). Based on the first stage sensing inference data 430, the sensing edge server 440 generates second stage sensing inference data 450 and provides or transmits those to the sensing application server 460 in order for the sensing application server 460 to be able to provide sensing-related services and/or generate sensing application data. It is thereby advantageously possible, according to the present invention, to make use of the hierarchical and service-oriented architecture of the cellular mobile broadband network 100. Thereby, for each inference step best-of-bread methods can be applied. According to the present invention, it is especially preferred to use open interfaces
between the sensing-capable or sensing-enabled entities or functionalities 111, 112, 113 and the sensing edge server(s) 440, and/or
between the sensing edge server(s) 440 and the sensing application server (460).
   According to the present invention, such cascading of sensing data inference especially provides the following benefits:
raw data inference can be carried out at the receivers in real time;
deep insights into radio specific functionalities are hidden;
the amount of data to be provided to the next inference step is limited;
cellular data fusion is supported when combining processed sensing data from relevant neighboring receivers;
open architecture allows reuse and optimization of cascading process;
application servers for specific use cases can build on generalized extracted insights provided by application programming interfaces, APIs.

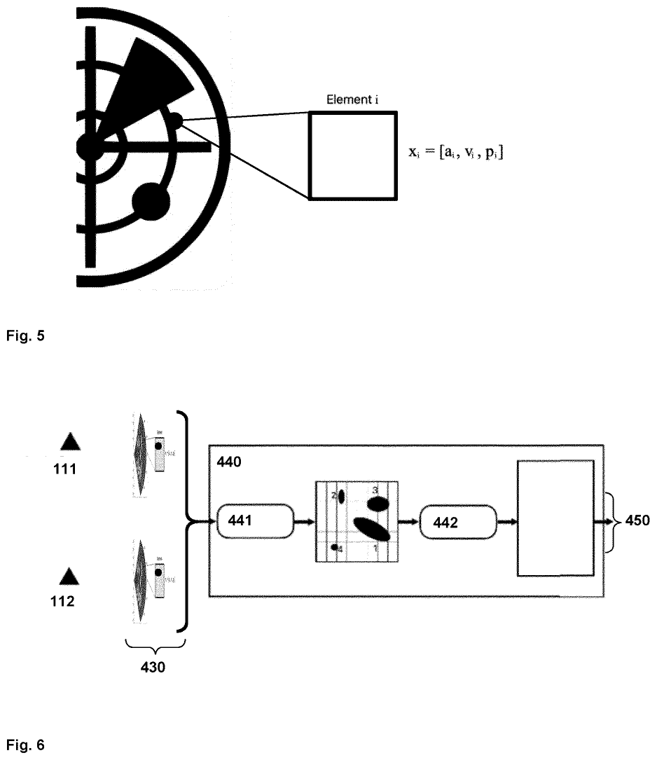

FIG. 5 schematically and exemplarily illustrates a possibility of first stage sensing inference data 430, especially as a radar-like image having multiple targets (schematically illustrated, in FIG. 5, via circles or dots at different distances and at different angles from the sensing center), wherein exemplarily the optional possibility of a data element is exemplarily represented as a feature vector, especially for facilitating to process sensing data for object detection/localization/tracking use cases which is described in the following: The sensing base station(s) 111, 112, 113 evaluate(s) sensing raw data based on RX measurements (i.e. measurements of the radiofrequency sensing reception signals), such as ToA, AoA, AoD, and Doppler from the various beams of, typically, massive multiple input multiple output, MIMO, antennas. Thereby, the specific dependencies on frequency bands, bandwidth, duplex scheme, reference signals etc. are considered.

Preferably according to the present invention, this result is provided (especially as part of first stage sensing inference data 430), especially in a radar-like image, and especially in a relative coordinate system; however, absolute coordinates could be applied or used here alternatively or cumulatively, though this is not required as long the sensing edge server 440 is able to derive absolute coordinates from relative results.

According to the present invention, these images (i.e. such first stage sensing inference data 430) are able to be a static and human-recognizable two-dimensional or three-dimensional image of the respective sensing base station's 111, 112, 113 coverage area. Preferably, such images are able to be enhanced with further information (feature vector, especially for facilitating to process sensing data for object detection/localization/tracking use cases) available during such local analysis at the sensing base station 111, 112, 113 (e.g. velocity indications from doppler measurements, range resolution, angular resolution, channel observations) to support subsequent (sensing-related) inferences. Time-sequencing of these static images to time-stamped image streams are able to provide the basis for object tracking. Hence, a purely image-like representation of initial sensing inference by the sensing base station 111, 112, 113 (first stage sensing inference data 430) is able to be enhanced—or complemented—according to the present invention, since the sensing base station 111, 112, 113 obtains several pieces of information from the sensing measurements; especially for each measurement element, the sensing base station 111, 112, 113 may provide a vector of features, i.e. an image element i (or a part i of the image—in FIG. 5 represented via a square and the indication “Element i”) may provide a feature vector xᵢ=[aᵢ, vᵢ, pᵢ], whereby, e.g., aᵢ describes the intensity of the received signal, vᵢ describes the relative velocity derived from doppler measurements and pᵢ the self-assessment of sensing base station's 111, 112, 113 inference accuracy/precision.

The relative location of this element i is, especially determined by ranging (range plus angle) by the sensing base station 111, 112, 113—typically in its local coordinate system. The size of the element is mainly determined by the sensing base station's 111, 112, 113 ranging resolution and angular resolution (in FIG. 5 and for the sake of simplification, element i is shown as a square (or: in rectangular shape) for illustration purposes; in real-world scenarios and implementations, the element shape will rather follow the shape of a circular sector or a sector-element shape). Hence, according to a preferred embodiment of the present invention, the sensing base station 111, 112, 113 may not provide a full “image”, but only those elements with significant sensing information; however, in the following, it is referred to “images” and “image streams” for the sake of simplicity.

FIG. 6 schematically and exemplarily illustrates inference steps performed in (or at) the sensing edge server 440: The sensing edge server 440 receives the radar-like images/image streams (or: first stage sensing inference data 430) from one or multiple sensing base stations 111, 112, 113—especially periodically, (quasi-)continuously, or at specific points in time or on a subscription basis—, wherein FIG. 6 exemplarily depicts the first and second sensing-related or sensing-enabled entities or functionalities 111, 112 providing first stage sensing inference data 430 to the sensing edge server 440.

Especially via data fusion of these images and image streams, respectively, (i.e. of the first stage sensing inference data 430) into an absolute coordinate system and subsequent model- or AI/ML-based inference the sensing edge server 440 is able to derive results on:
object detection;
object identification (e.g., shape, material, body);
object localization (in absolute coordinate system), wherein this typically requires to know in advance the absolute position of base station antennas (i.e. of the sensing-capable or sensing-enabled entities or functionalities 111, 112, 113) and their orientations;
object tracking;
environment information (buildings, plants, etc.).

Preferably according to the present invention, this is realized via conducting a first sub-step (of the first step according to the present invention), during which the sensing edge server 440 performs a first inference step 441, and via conducting a second sub-step (of the first step according to the present invention), during which the sensing edge server 440 performs a second inference step 442; both sub-steps are schematically shown in FIG. 6.

The first sub-step or first inference step 441 especially involves the preprocessed information obtained from the sensing base stations 111, 112, 113 (i.e. the first stage sensing inference data 430) being transformed from local information into a general coordinate system, thereby especially applying geographic coordinates (e.g. according to the world geodetic system 1984, WGS84) or specific cartesian coordinates valid for the specific area of investigation (for instance when applied for distinct indoor or outdoor campus areas). Thereby, the sensing edge server 440 may fuse input data from various sensing base stations 111, 112, 113 covering the same area.

The second sub-step or second inference step 442 especially involves the sensing edge server 440 identifying the various objects and providing object information, especially defined data on object-level (such as, e.g., “Object 1: { . . . }, Object 2: { . . . }, Object 3: { . . . }, Object 4: { . . . }”). These results are provided in a defined format (and corresponding to the second stage sensing inference data 450) by the sensing edge server 440 to the sensing application server 460, e.g. using a representation in a JSON formatted template for a single object.

Upon the data—i.e. the second stage sensing inference data 450—being provided by the sensing edge server 440, the sensing application server 460 can realize the individual use case application.

The sensing edge server 440 typically services sensing data (i.e. the second stage sensing inference data 450) in a generalized granularity, so that subsequent sensing application server 460 can support specific use cases.

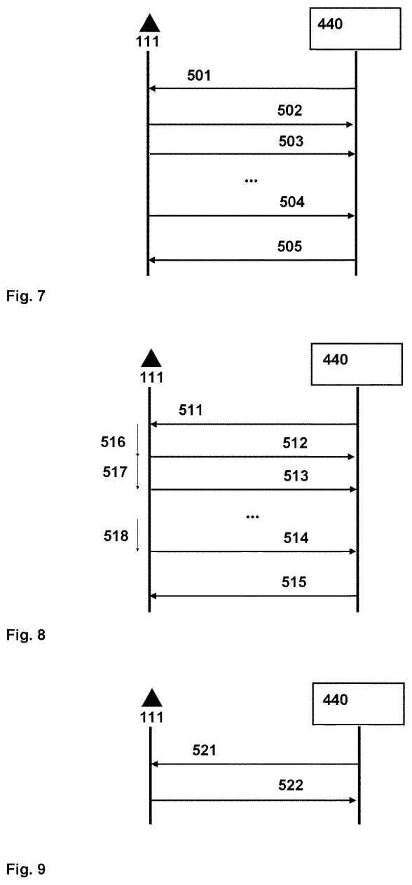

FIGS. 7, 8 and 9 schematically and exemplarily illustrate different examples of the information exchange between the sensing edge server 440 and the (first) sensing-capable or sensing-enabled entity or functionality 111, when the first requests from the latter continuous mode (FIG. 7), periodic mode (FIG. 8) and one-shot request (FIG. 9), respectively. FIG. 7 shows, in a first processing step 501 a request message transmitted by the sensing edge server 440 to the (first) sensing-capable or sensing-enabled entity or functionality 111, the request message requesting a stream (or a continuous mode) transmission. In subsequent second, third, fourth and fifth processing steps 502, 503, 504, 505, the (first) sensing-capable or sensing-enabled entity or functionality 111 transmits, respectively, sensing updates or sensing update messages. Hence, in this respect, the continuous mode corresponds to the sensing base station(s) 111 being able to continuously provide streams of sensing images, the sensing edge server 440 being able to continuously update object information.

FIG. 8 shows, in a first processing step 511 a request message transmitted by the sensing edge server 440 to the (first) sensing-capable or sensing-enabled entity or functionality 111, the request message requesting a periodic update transmission (especially indicating a time interval or delta t information). In subsequent second, third, fourth and fifth processing steps 512, 513, 514, 515, the (first) sensing-capable or sensing-enabled entity or functionality 111 transmits, respectively, sensing updates or sensing update messages, especially after time intervals 516, 517, 518 corresponding to the indicated time interval or delta t information. Hence, in this respect, the periodic mode corresponds to the sensing edge server 440 periodically updates the sensing information. This periodicity is negotiated between the sensing edge server 440 and the (first) sensing-capable or sensing-enabled entity or functionality 111 and/or between the sensing edge server 440 and the sensing application server 460.

FIG. 9 shows, in a first processing step 521 a request message transmitted by the sensing edge server 440 to the (first) sensing-capable or sensing-enabled entity or functionality 111, the request message requesting an update (or a one-shot) transmission. In a subsequent second processing step 522, the (first) sensing-capable or sensing-enabled entity or functionality 111 transmits a sensing update or sensing update message. Hence, in this respect, the one-shot request corresponds to the first stage sensing inference data 430 being transmitted once, especially due to the sensing application server 460 requesting one-time sensing information from the sensing edge server 440 (and, hence, the sensing edge server 440 requesting a one-time transmission from the (first) sensing-capable or sensing-enabled entity or functionality 111).

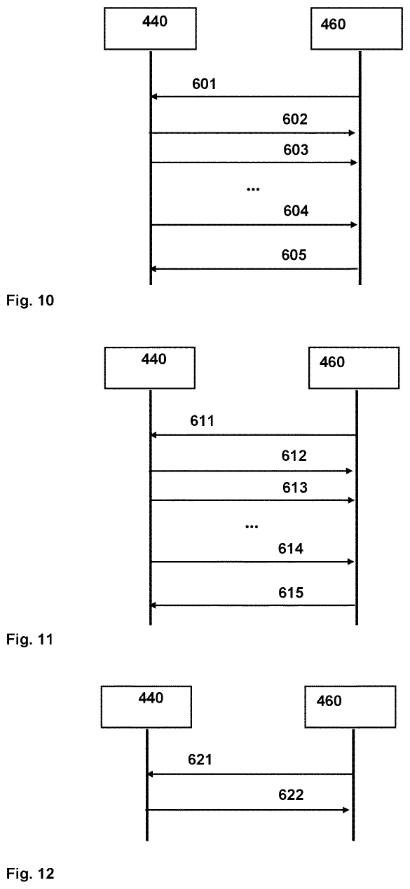

FIGS. 10, 11 and 12 schematically and exemplarily illustrate different examples of the information exchange and the interface between the sensing edge server 440 towards the sensing application server 460, showing different approaches, especially stream-based application programming interface (FIG. 10), Pub/Sub application programming interface (FIG. 11), and REST application programming interface (FIG. 12), respectively.

FIG. 10 shows, in a first processing step 601 a request message transmitted by the sensing application server 460 to the sensing edge server 440, the request message requesting a continuous update mode transmission. In subsequent second, third and fourth processing steps 602, 603, 604, the sensing edge server 440 transmits, respectively, sensing information or sensing information messages to the sensing application server 460. In a fifth processing step 605, the sensing application server 460 requests from the sensing edge server 440 to stop the transmission of sensing information messages.

FIG. 8 shows, in a first processing step 611 a request message transmitted by the sensing application server 460 to the sensing edge server 440, the request message corresponding to a subscribe message in view of a publication/subscription mode transmission. In subsequent second, third and fourth processing steps 612, 613, 614, the sensing edge server 440 transmits, respectively, sensing information or sensing information messages to the sensing application server 460. In a fifth processing step 615, the sensing application server 460 requests from the sensing edge server 440 to stop the transmission of sensing information messages via an unsubscribe message.

FIG. 9 shows, in a first processing step 621 a request message transmitted by the sensing application server 460 to the sensing edge server 440, the request message corresponding to a GET message (especially comprising an area indication or area information) in view of a REST application programming interface mode transmission. In a subsequent second processing step 622, the sensing edge server 440 transmits a sensing response or sensing information message to the sensing application server 460.

Regarding all of these transmission modes between the sensing edge server 440 and the sensing application server 460, when triggering sensing inference, the sensing application server 460 requests from the sensing edge server 440 sensing detection information for a specific area or multiple areas of interest. As a result, the sensing edge server 440 prepares the object data according to this request.

An example of such data, provided by the sensing edge server 440, is given in the following:

Detected objects are identified by an identifier information—their object ID (objectId) generated by the sensing edge server 440 upon recognition of a new object and maintained as long as the respective object can be tracked:

```
{
  “objectId”: ...
  “timeStamp”: ...
  “objectLocation”: {
    “coordinateReferenceSystern : ...
    “latitude”: ...
    “longitude”: ...
    “elevation”: ...
    “resolution”: ...
    “precision”: ...
  },
  “objectProperties”: {
    “orientation”: ...
    “speed”: ...
    “objectShape”: ...
    “surfaceType”: ...
  },
    “objectEnvironment”: {...}
}
{
“areaList”: [
    {
    “selectedArea”: {...},
    “detectionList”: [object1, object2, ... , objectN],
    “timeStamp”: ...
    }, ...
  ]
}
```

Hence, the interface of sensing edge server 440 towards sensing application server 460 can be realized in various ways. The different approaches may vary depending on the operation mode addressed, such as:
REST API: This is specifically beneficial for applications that use one-shot requests only.
Pub/Sub API: Publication-Subscribe methods may make use of WebSockets, MQTT or similar. This may be best suited for periodic mode operation.
Stream-based API: This may be best for continuous mode.

Other application interface methods may be applied that may evolve during definition of 6G systems.

Typically, it is up to the sensing edge server 440 which sensing operation mode (or transmission mode) and procedures it triggers towards the involved sensing base stations 111, 112, 113 upon requests from sensing application server(s) 460. For instance, more than one sensing application servers 460 may be subscribed to sensing information from one specific sensing area. Then it is up to the sensing edge server 440 to request continuous mode or periodic mode from the involved sensing base stations 111, 112, 113. In this sense, the sensing edge server determines also the set of sensing base stations required for sensing inference.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1-11. (canceled)

12. A method for providing at least one sensing-related service by means of processing sensing-related data that is generated within or as part of a mobile communication network,
wherein the mobile communication network comprises at least a first sensing-capable or sensing-enabled entity or functionality and a second sensing-capable or sensing-enabled entity or functionality, wherein the at least one sensing-capable or sensing-enabled entity or functionality transmits a radiofrequency sensing signal, wherein, as a result of the radiofrequency sensing signal being transmitted, a radiofrequency sensing reception signal is received by either the first sensing-capable or sensing-enabled entity or functionality or the second sensing-capable or sensing-enabled entity or functionality or both, wherein by means of the radiofrequency sensing reception signal information about the environment of the first and second sensing-capable or sensing-enabled entities or functionalities is able to be gathered as first stage sensing inference data,
wherein the mobile communication network comprises or is associated or assigned to at least one sensing edge server and at least one sensing application server,
wherein, in order to provide at least one sensing-related service, the method comprises the following steps:
in a first step, the first stage sensing inference data are provided to the at least one sensing edge server, wherein the at least one sensing edge server generates second stage sensing inference data, wherein, in a first sub-step of the first step, the sensing edge server performs a first inference step, and wherein, in a second sub-step of the first step, the sensing edge server performs a second inference step, wherein the second stage sensing inference data correspond to the result of the second inference step, wherein the first inference step involves data fusion of different first stage sensing inference data provided by different sensing-capable or sensing-enabled entities or functionalities into a general coordinate system or into an absolute coordinate system, wherein the second inference step involves the sensing edge server identifying objects and providing object information,
in a second step, the second stage sensing inference data are provided to the at least one sensing application server, wherein the at least one sensing application server provides sensing-related services and/or generates sensing application data.

13. The method according to claim 12, wherein the first and second sensing-capable or sensing-enabled entities or functionalities use sensing raw data, especially based on radiofrequency transmission and/or reception measurements, especially time-of-arrival data (ToA data), angle-of-arrival data (AoA data), angle-of-departure data (AoD data), and/or doppler data, especially from the various beams of at least one massive multiple input multiple output (MIMO) antenna entity or functionality, wherein especially the first and second sensing-capable or sensing-enabled entities or functionalities are used for integrated communication and sensing (ICaS) and/or for joint communication and sensing (JCaS) capabilities, and especially serve both communication purposes and sensing purposes.

14. The method according to claim 12, wherein the first stage sensing inference data comprise at least one out of the following:
radar-like images, especially in a relative coordinate system,
elements with significant sensing information,
further information available during local analysis at the first and second sensing-capable or sensing-enabled entities or functionalities, especially velocity indications, especially inferred from doppler measurements, range resolution, angular resolution, channel observations,
time-sequencing of static images, especially time-stamped image streams, especially of radar-like images,
a vector of features regarding at least a part of the radar-like images, the vector of features especially comprising data regarding
the intensity of the received signal,
the relative velocity derived from doppler measurements and/or
a self-assessment information regarding one or a plurality of the inferred properties based on the respective sensing-capable or sensing-enabled entity or functionality.

15. The method according to claim 12, wherein the object information is defined data on object level, especially in a defined format, preferably using JavaScript Object Notation, JSON.

16. The method according to claim 12, wherein the second stage sensing inference data are generated by means of at least one out of the following:
receiving different first stage sensing inference data or streams of first stage sensing inference data,
model inference and/or artificial intelligence-based or machine learning-based inference such as to derive results on:
object detection,
object identification, especially the shape, the material and/or the body of the object,
object localization, especially in the absolute coordinate system,
object tracking,
environment information, especially regarding buildings or plants, wherein especially, the second stage sensing inference data comprise a generalized granularity.

17. The method according to claim 12, wherein the first stage sensing inference data are transmitted, by the different sensing-capable or sensing-enabled entities or functionalities, and received, by the sensing edge server involving or according to at least one out of the following:
a continuous mode, wherein the sensing-capable or sensing-enabled entities or functionalities almost continuously provide streams of first stage sensing inference data, and the sensing edge server is almost continuously able to update object information,
a periodic mode, wherein the sensing edge server periodically updates the sensing information, wherein the periodicity is especially negotiated between the sensing-capable or sensing-enabled entities or functionalities and the sensing edge server,
a one-shot request, wherein the sensing edge server requests one-time sensing information from the sensing-capable or sensing-enabled entities or functionalities.

18. The method according to claim 12, wherein the second stage sensing inference data are transmitted, by the sensing edge server, and received, by the sensing application server,
involving an application programming interface, especially according to at least one out of the following:
a representational state transfer (REST) application programming interface, especially in case that the sensing edge server requests one-time sensing information from the sensing-capable or sensing-enabled entities or functionalities,
a publication-subscription application programming interface, especially using WebSocket, MQ telemetry transport (MQTT), especially in case that the sensing edge server and the sensing-capable or sensing-enabled entities or functionalities communicate according to the periodic mode operation,
a stream-based application programming interface, especially in case that the sensing edge server and the sensing-capable or sensing-enabled entities or functionalities communicate according to the continuous mode operation.

19. A system or mobile communication network for providing at least one sensing-related service by means of processing sensing-related data that is generated within or as part of a mobile communication network,
wherein the mobile communication network comprises at least a first sensing-capable or sensing-enabled entity or functionality and a second sensing-capable or sensing-enabled entity or functionality, wherein the at least one sensing-capable or sensing-enabled entity or functionality transmits a radiofrequency sensing signal, wherein, as a result of the radiofrequency sensing signal being transmitted, a radiofrequency sensing reception signal is received by either the first sensing-capable or sensing-enabled entity or functionality or the second sensing-capable or sensing-enabled entity or functionality or both, wherein by means of the radiofrequency sensing reception signal information about the environment of the first and second sensing-capable or sensing-enabled entities or functionalities is able to be gathered as first stage sensing inference data,
wherein the mobile communication network comprises or is associated or assigned to at least one sensing edge server and at least one sensing application server,
wherein, in order to provide at least one sensing-related service, the system of mobile communication network is configured such that:
the first stage sensing inference data are provided to the at least one sensing edge server, wherein the at least one sensing edge server generates second stage sensing inference data, wherein, in a first sub-step of the first step, the sensing edge server performs a first inference step, and wherein, in a second sub-step of the first step, the sensing edge server performs a second inference step, wherein the second stage sensing inference data correspond to the result of the second inference step, wherein the first inference step involves data fusion of different first stage sensing inference data provided by different sensing-capable or sensing-enabled entities or functionalities into a general coordinate system or into an absolute coordinate system, wherein the second inference step involves the sensing edge server identifying objects and providing object information,
the second stage sensing inference data are provided to the at least one sensing application server, wherein the at least one sensing application server provides sensing-related services and/or generates sensing application data.

20. A sensing edge server, especially as part of a system or mobile communication network according to claim 19, for providing at least one sensing-related service by means of processing sensing-related data that is generated within or as part of a mobile communication network,
wherein the sensing edge server communicates with at least first and second sensing-capable or sensing-enabled entities or functionalities, wherein the sensing-capable or sensing-enabled entities or functionalities gather information about their environment as first stage sensing inference data,
wherein, in order to provide at least one sensing-related service, the sensing edge server is configured such that:
the first stage sensing inference data are provided, by the sensing-capable or sensing-enabled entities or functionalities, to the at least one sensing edge server, wherein the sensing edge server generates second stage sensing inference data, wherein, in a first sub-step of the first step, the sensing edge server performs a first inference step, and wherein, in a second sub-step of the first step, the sensing edge server performs a second inference step, wherein the second stage sensing inference data correspond to the result of the second inference step, wherein the first inference step involves data fusion of different first stage sensing inference data provided by different sensing-capable or sensing-enabled entities or functionalities into a general coordinate system or into an absolute coordinate system, wherein the second inference step involves the sensing edge server identifying objects and providing object information,
the second stage sensing inference data are provided to the at least one sensing application server, wherein the at least one sensing application server provides sensing-related services and/or generates sensing application data.

21. A program comprising a computer readable program code, which, when executed in part on first and second sensing-capable or sensing-enabled entities or functionalities and in part on a sensing edge server and in part on a sensing application server, causes the first and second sensing-capable or sensing-enabled entities or functionalities and the sensing edge server and the sensing application server to perform a method according to claim 12.

22. A computer-readable medium comprising instructions which when executed in part on first and second sensing-capable or sensing-enabled entities or functionalities and in part on a sensing edge server and in part on a sensing application server, causes the first and second sensing-capable or sensing-enabled entities or functionalities and the sensing edge server and the sensing application server to perform a method according to claim 12.
